(19) United States
(12) Patent Application Publication
(10) Pub. No.: US 2007/0183367 A1
(43) Pub. Date: Aug. 9, 2007

(54) Method and apparatus of searching for and acquiring handover information using dynamic host configuration protocol

(75) Inventor: Soo-hong Park, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/647,335

(22) Filed: Dec. 29, 2006

Related U.S. Application Data
(60) Provisional application No. 60/765,201, filed on Feb. 6, 2006.

(30) Foreign Application Priority Data
Jun. 19, 2006 (KR) 2006-54914

(51) Int. Cl. H04Q 7/00

(52) U.S. Cl. 370/331

(57) ABSTRACT

Provided are a method and apparatus for searching for and acquiring handover information using a Dynamic Host Configuration Protocol (“DHCP”). The handover information searching and acquiring method includes: receiving the location information of an information server, which can provide the handover information, from a Dynamic Host Configuration Protocol (DHCP) server; accessing the information server using the location information; and receiving the handover information from the information server. By receiving the location information of an information server, which can provide handover information, using DHCP, and by receiving the handover information from the information server using the location information, it is possible to quickly and efficiently search for and acquire handover information.

### CROSS-REFERENCE TO RELATED APPLICATIONS

This application claims all benefits accruing under 35 U.S.C. §119 and §120 from U.S. Patent Application No. 60/765,201, filed on Feb. 6, 2006, in the U.S. Patent and Trademark Office, and of Korean Patent Application No. 2006-54914, filed on Jun. 19, 2006, in the Korean Intellectual Property Office, the disclosures of which are incorporated herein by reference.

### BACKGROUND OF THE INVENTION

1. Field of the Invention

The present invention relates to mobile communications, and more particularly, to a method and apparatus for searching for and acquiring handover information using a Dynamic Host Configuration Protocol (“DHCP”).

2. Related Art

Handover in mobile communication is a technique which allows a mobile node to continuously receive a currently used service when a mobile node (“MN”) is moving. In order to perform a handover, information about a new network to which a mobile node will move to is needed. This information is called “handover information.”

In order to quickly and efficiently perform a handover, it is necessary to quickly and efficiently search for and acquire such handover information.

### SUMMARY OF THE INVENTION

Several aspects and embodiments of the present invention provide a method and apparatus for quickly and efficiently searching for and acquiring handover information.

Additional aspects and/or advantages of the invention will be set forth in part in the description which follows and, in part, will be obvious from the description, or may be learned by practice of the invention.

In accordance with an embodiment of the present invention, there is provided a method of searching for and acquiring handover information, which includes receiving the location information of an information server, which can provide the handover information, from a Dynamic Host Configuration Protocol (“DHCP”) server; accessing the information server using the location information; and receiving the handover information from the information server.

In accordance with another embodiment of the present invention, there is provided an apparatus for searching for and acquiring handover information, which includes an information receiver to receive the location information of an information server, which can provide the handover information, from a Dynamic Host Configuration Protocol (“DHCP”) server; an access unit to access the information server, using the location information; and a handover information receiver to receive the handover information from the information server.

In accordance with another embodiment of the present invention, there is provided a computer readable recording medium having embodied thereon a computer program for executing a method, which includes receiving the location information of an information server, which can provide handover information, from a Dynamic Host Configuration Protocol (“DHCP”) server; accessing the information server using the location information; and receiving the handover information from the information server.

In addition to the example embodiments and aspects as described above, further aspects and embodiments will be apparent by reference to the drawings and by study of the following descriptions.

### BRIEF DESCRIPTION OF THE DRAWINGS

A better understanding of the present invention will become apparent from the following detailed description of example embodiments and the claims when read in connection with the accompanying drawings, all forming a part of the disclosure of this invention. While the following written and illustrated disclosure focuses on disclosing example embodiments of the invention, it should be clearly understood that the same is by way of illustration and example only and that the invention is not limited thereto. The spirit and scope of the present invention are limited only by the terms of the appended claims. The following represents brief descriptions of the drawings, wherein:

FIG. 1 is a block diagram of a handover information searching and acquiring apparatus, according to an example embodiment of the present invention;

FIG. 2 is a view illustrating a mobile communication environment in which handover information is searched for and acquired, according to an example embodiment of the present invention;

FIG. 3 is a view illustrating network layers of a mobile node, according to an example embodiment of the present invention;

FIG. 4 is a flowchart illustrating a handover information searching and acquiring method, according to an example embodiment of the present invention;

FIG. 5 is an illustration of a Dynamic Host Configuration Protocol (DHCP) message, according to an example embodiment of the present invention;

FIG. 6 is a flowchart illustrating a location information receiving process, according to an example embodiment of the present invention;

FIG. 7 is a view illustrating a location discovery option, according to an example embodiment of the present invention; and

FIG. 8 illustrates a location information sub option of the location discovery option illustrated in FIG. 7, according to an example embodiment of the present invention.

### DETAILED DESCRIPTION OF THE EMBODIMENTS

Reference will now be made in detail to embodiments of the present invention, examples of which are illustrated in the accompanying drawings, wherein like reference numerals refer to the like elements throughout. The embodiments of the invention are not limited to those shown in the drawings, and various changes in form and details may be made therein without departing from the spirit and scope of the present invention. The embodiments are described below in order to explain the present invention by referring to the figures.

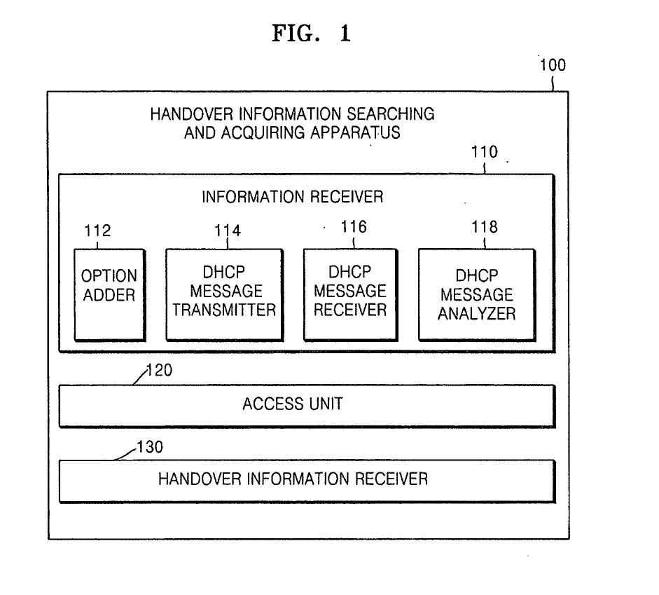

FIG. 1 is a block diagram of a handover information searching and acquiring apparatus 100, according to an example embodiment of the present invention. Referring to FIG. 1, the handover information searching and acquiring apparatus 100 includes an information receiver 110, an access unit 120, and a handover information receiver 130. The information receiver 110 includes an option adder 112, a Dynamic Host Configuration Protocol (“DHCP”) message transmitter 114, a DHCP message receiver 116, and a DHCP message analyzer 118.

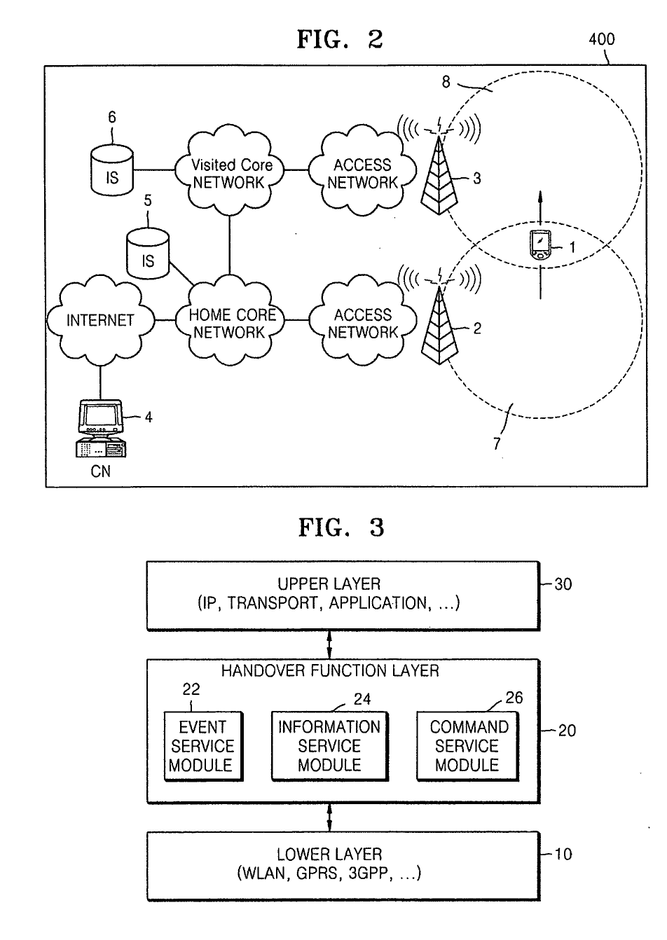

The handover information searching and acquiring apparatus 100 searches for and acquires information required for the handover of a mobile node (such as, the mobile node 1 shown in FIG. 2), and provides the acquired information to the mobile node. The handover information searching and acquiring apparatus 100 may be provided as a part of the mobile node.

FIG. 2 is a view illustrating a mobile communication environment 400 in which handover information is searched for and acquired, according to an example embodiment of the present invention. Referring to FIG. 2, the mobile communication environment 400 is composed of a mobile node 1, DHCP servers 2 and 3, a correspondent node 4, information servers 5 and 6, network areas 7 and 8, and a plurality of networks.

A network topology in the mobile communication environment 400 illustrated in FIG. 2 is merely an example. Various other topologies can also be constructed.

The mobile node 1 is a mobile terminal, such as, for example, a mobile phone, a personal digital assistant (PDA), and other portable devices in environment 400. When first entering or beginning use of mobile communications in the environment 400, the mobile node 1 registers a home address (“HoA”) with a home agent on a home network. When the mobile node 1 moves to a different network area, such as from network area 7 to network area 8, that the mobile node 1 has not been to before, a foreign agent on the new network area assigns to mobile node 1 a care-of address (“CoA”). The mobile node 1 acquires the CoA, sends it to the home agent, and registers it with the home agent. The home agent correlates the CoA with the home address, and transmits data to the CoA when data is transmitted to the HoA by the correspondent node 4. Thus, the mobile node 1 can continue to receive transmissions from the correspondent node 4 when the mobile node 1 moves to a new network area 8.

The mobile node 1, before moving to a new network area 8, is connected to its current network through a point of attachment (“PoA”) located in the current network area 7. The PoA is an apparatus that transmits data between the mobile node 1 and the current network. The PoA includes an Access Point (“AP”), or a base station, etc. However, the present invention is not limited to these, and the point of attachment can be an arbitrary apparatus in which data transmission is performed between the mobile node 1 and a network. In FIG. 2, the DHCP servers 2 and 3 can be respective PoAs in the corresponding network areas 7 and 8.

When the mobile node 1 moves to the new network area 8, a handover is performed. In order for the mobile node 1 to perform a handover from a current network area 7 to a new network area 8, information regarding the new network is required. This information is known as “handover information.” FIG. 2 illustrates an example in which the mobile node 1 moves from network area 7 to a new network area 8. In network area 8, data communication is performed using the DHCP server 3 as a PoA. In network area 7, the mobile node 1 performs data communication in using the DHCP server 2 as a PoA.

The mobile node 1 receives information regarding the new network area 8 from the DHCP server 2 PoA in the network area 7 before the mobile node 1 moves into the new network area 8. The information, which is one portion of the handover information, is transmitted from the information servers 5 and 6. The mobile node 1 acquires information about the network in the new network area 8, information such as the network protocol used in the new network area 8, and on the basis of the received information is able to perform a handover.

FIG. 3 is a view illustrating network layers of a mobile node, according to an example embodiment of the present invention. Referring to FIG. 3, the network layers of the mobile node include a lower layer 10, a handover function layer 20, and an upper layer 30.

The lower layer 10 refers to the first and second layers (a link layer and a physical layer) of the seven layers defined by the Open Systems Interconnection (“OSI”) reference model. The upper layer 30 refers to the third layer through seventh layers (an internet protocol (“IP”) layer, a mobile IP layer, a transport layer, a session layer, a presentation layer, and an application layer) of the of the seven layers defined by the OSI reference model.

The handover function layer 20 corresponds to an intermediate 2.5 layer between the lower layer 10 and the upper layer 30, and supports a handover between the lower layer 10 and the upper layer 30.

The handover function layer 20 supports handover between different types of links, regardless of the type of link interfaces of the lower layer 10. To accomplish handover between different types of links, the handover function layer 20 may include an event service module 22, an information service module 24, and a command service module 26.

Referring to FIGS. 2 and 3, the event service module 22 detects an event related to handover between various links, generated by the mobile node 1 shown in FIG. 2, and notifies the upper layer 30 of the event. The information service module 24 acquires handover information from the information servers 5 and 6 shown in FIG. 2. The command service module 26 receives a command input by a user from the upper layer 30 and controls handover of the lower layer 10.

The mobile node 1 receives handover information regarding the new network area 8 to which the mobile node 1 is moving into from the information servers 5 and 6 shown in FIG. 2. The mobile node 1 can recognize location information of an information server having handover information regarding the new network area 8 to which the mobile node 1 is moving into by using the handover information searching and acquiring apparatus according to an example of the present invention.

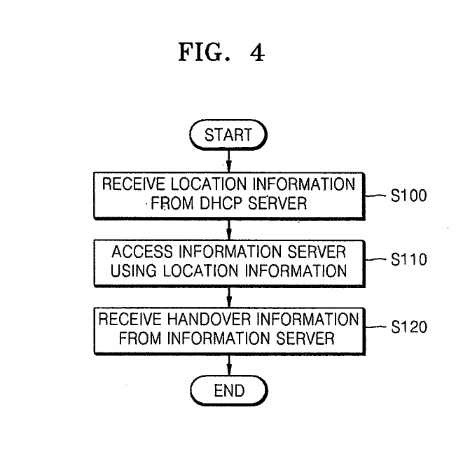

FIG. 4 is a flowchart illustrating a handover information searching and acquiring method according to an example embodiment of the present invention.

Referring to FIGS. 1, 2, and 4, if the mobile node 1 moves to a new network area 8, the mobile node 1 accesses the DHCP server 2 and receives location information of an information server 6 (operation S100). The operation S100 is performed in the information receiver 110 of FIG. 1. The information server 6 provides the handover information to the mobile node 1. In the current example embodiment, the mobile node 1 is a DHCP client.

The location information of the information server 6 received from the DHCP server 2 is transmitted to the access unit 120 shown in FIG. 1.

The access unit 120 accesses the information server 6 using the location information of the information server 6, and requests handover information from the information server 6 (S110). When the information server 6 transmits the handover information, the handover information receiver 130 receives the handover information from the information server 6 (S120). Then, the mobile node 1 can perform handover using the received handover information.

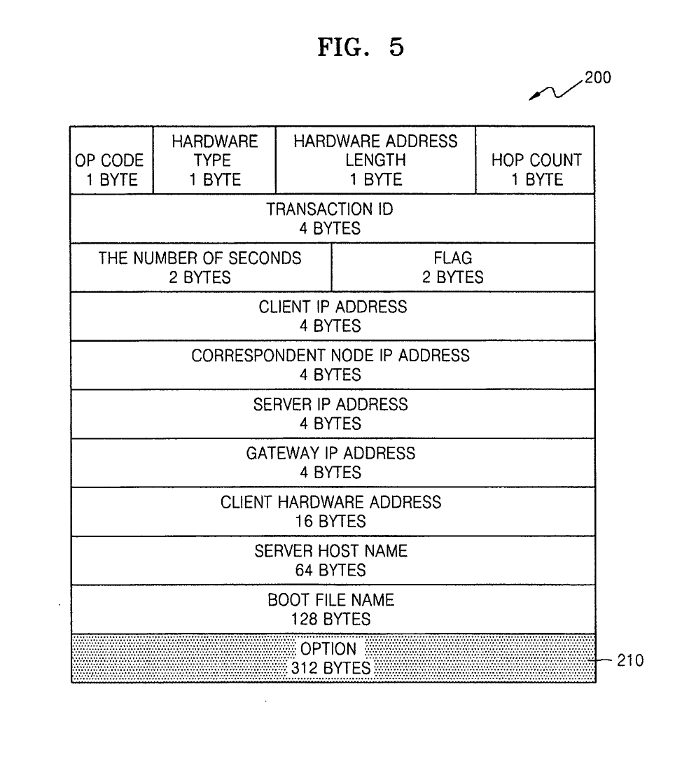

The information receiver 110 shown in FIG. 1 may receive the location information of the information server using an option function of a DHCP message. The option function of the DHCP message will now be described with reference to FIG. 5.

FIG. 5 is an illustration of a DHCP message 200 according to an example embodiment of the present invention. The DHCP message 200 includes various items, such as an OP code which represents a message type, a hardware type, a hardware address length, a hop count, etc. A DHCP server, such as DHCP server 2 shown in FIG. 2, and the DHCP client, such as the mobile node 1 shown in FIG. 2, transmit or receive such a DHCP message 200 to performing a DHCP process.

The DHCP message 200 includes a DHCP option 210. The DHCP option 210 can include content related to a specific function. For example, if the mobile node 1 DHCP client adds a value for requesting information required for host configuration to the DHCP option and sends the result of addition to the DHCP server 2, the DHCP server 2 adds the corresponding information to the corresponding location of the DHCP option and transmits the resulting DHCP message to the mobile node 1 DHCP client. The mobile node 1 DHCP client extracts desired information from the reply DHCP message so that it can use the information for host configuration. In the current example embodiment of the present invention, location information of an information server is received from a DHCP server 2, using a DHCP option function.

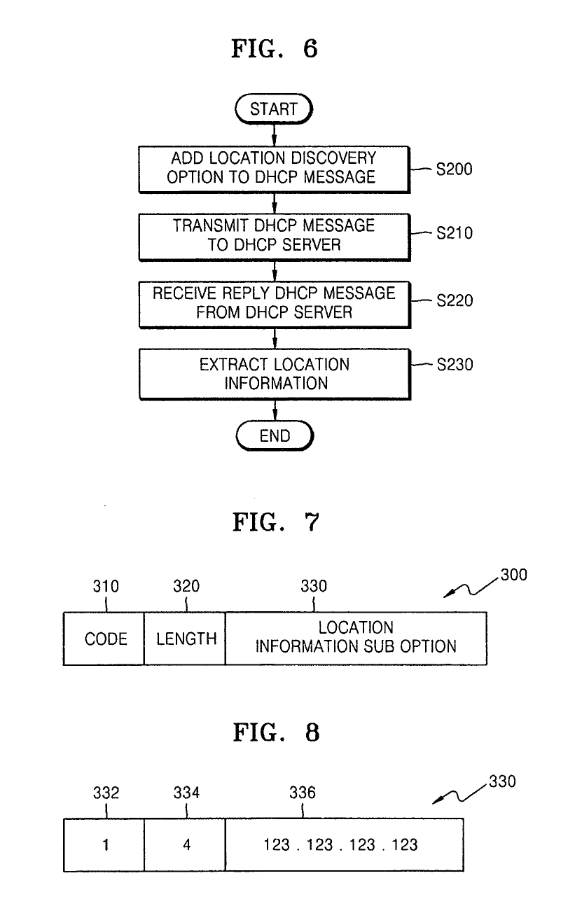

A process for transmitting the location information of a information server, which can provide handover information, using a DHCP option function will now be described with reference to FIG. 6. FIG. 6 is a flowchart illustrating a location information receiving process according to an example embodiment of the present invention.

The location information receiving process uses a location discovery option, in order to receive the location information from the DHCP server. A DHCP client, such as the mobile node 1 shown in FIG. 2, transmits a DHCP message to a DHCP server, such as the DHCP server 2 shown in FIG. 2. In the DHCP message, the location discovery option is in a null state. A DHCP message with an option in a null state indicates that the option includes only an option code for distinguishing the option from different options and an option length having a value “0” to indicate the null state. The DHCP message with the location discovery option in the null state does not transmit any data through the option, except for the option code and the option length. By sending a DHCP message with a null state for an option, the mobile node 1 (DHCP client) requests a value corresponding to the null state option.

In order to receive the location information of an information server from the DHCP server, first, the option adder 112 (shown in FIG. 1) adds a location discovery option, which does not include the location information of the information server (i.e., in a null state), to the DHCP message (S200).

The DHCP message transmitter 114 transmits the DHCP message containing the location discovery option, to the DHCP server, thereby requesting the location information of the information server (S210). If the DHCP server 2, while processing a DHCP message from the mobile node 1 (DHCP client), finds a location discovery option, the DHCP server 2 recognizes that the mobile node 1 (DHCP) client requests the location information of an information server 6, the information server 6 being able to provide handover information to the mobile node 1. Accordingly, the DHCP server 2 adds the location information to the location discovery option, and transmits a DHCP message which includes the location discovery option to the mobile node 1 (DHCP client).

The DHCP message receiver 116 (shown in FIG. 1) receives the DHCP message including the location discovery option and the location information of the information server, from the DHCP server (S220). The DHCP message analyzer 118 extracts the location information of the information server from the location discovery option (S230).

FIG. 7 illustrates a location discovery option 300 according to an example embodiment of the present invention. Referring to FIG. 7, the location discovery option 300 may include a field 310 indicating an option code, a field 320 indicating an option length, and a field 330 containing a location information sub option. The option code field 310 may have various values. The option length field 320 indicates the length of the location information sub option 330. Accordingly, if the location information sub option 330 is in a null state, the option length field 320 has a null value. In one aspect of the present invention, the option length field 320 represents the length of the information server location information sub option 330 in units of one byte.

The location information sub option 330 may include the location information of an information server. The location information of the information server is represented as a sub option because the location information of the information server may have various value formats. The information server location information sub option 330 may have several fields, examples of which are shown in FIG. 8.

FIG. 8 illustrates an example of the location information sub option 330 shown in FIG. 7. Referring to FIG. 8, the location information sub option 330 may include a field 332 indicating a code of a sub option, a field 334 indicating a length of the sub option, and a field 336 to contain location information.

The location information can be represented in several different formats, such as an Internet Protocol (“IP”) address of the information server, an Internet Protocol Version 6 (“IPv6”) address of the information server, a Fully Qualified Domain Name (“FQDN”) of the information server, a Uniform Resource Identifier (URI) of the server, or an Internationalized Resource Identifier (“IRI”) of the server.

According to an example embodiment of the present invention, when the location information of the information server is represented by an IP address, the sub option code field 332 may have a value of “1”. When the location information of the information server is represented by a FQDN, the sub option code field may have a value of “2”. When the location information of the information server is represented by a URI, the sub option code field 332 may have a value of “3”, and so on for the different formats. The value of the sub option code field 332 thus represents the format of the location information contained in field 336.

The sub option length field 334 represents the length of the field 336 containing the information server location information. According to an example embodiment of the present invention, the sub option length field 334 represents the length of the information server location information field 336 in units of one byte. Since several information servers for handover information may exist in the new network area, the field 336 indicating the location of the information servers may have several values.

If the information server location information is represented by an IP address of an information server, the information server location information may have 4 bytes of numeric data “123.123.123.123”, as in the example of FIG. 8, (if the corresponding IP version is 4), or have 16 bytes of numeric data (if the corresponding IP version is 6). If the information server location information is represented by a FQDN of an information server, the information server location information may have a value, such as, for example, “http://information_server.domain.com.”When the information server location information is represented by a URI, data for handover information can be used when desired handover information is stored only in a specific information server. The URI is a technical concept including a Uniform Resource Locator (“URL”) and a Uniform Resource Name (“URN”).

For example, if handover information a is stored in an information server info_server and the information server info_server has a value of 123.123.123.123 as its IP address, the location of an information server for the handover information a can have a value such as “a:infor_server:123.123.123.123.” Location information represented by an IRI is processed in a similar manner to location information represented by an URI value, with the IRI representation allowing a wider character set for data.

The present invention can be implemented by a computer (including all apparatuses having an information processing function) readable code in a computer readable recording medium. The computer readable recording medium includes all types of recording apparatuses in which data capable of being read by a computer system is stored. The computer readable recording medium may be ROMs, RAMs, CD-ROMs, magnetic tapes, floppy discs, optical data storage devices, etc.

While there have been illustrated and described what are considered to be example embodiments of the present invention, it will be understood by those skilled in the art and as technology develops that various changes and modifications, may be made, and equivalents may be substituted for elements thereof without departing from the true scope of the present invention. Many modifications, permutations, additions and sub-combinations may be made to adapt the teachings of the present invention to a particular situation without departing from the scope thereof. For example, the various networks shown in FIG. 1 may themselves be wireless networks. Alternatively, the wireless network may be of various protocols and communication mediums, such as a Bluetooth network, a Global System for Mobile Communications network, or an infrared network. Accordingly, it is intended, therefore, that the present invention not be limited to the various example embodiments disclosed, but that the present invention includes all embodiments falling within the scope of the appended claims.

In a handover information searching and acquiring method and apparatus, according to the present invention, it is possible to quickly and efficiently search for and acquire handover information by receiving location information of an information server which provides handover information, using a DHCP, and by receiving the handover information from the information server using the location information of the information server.

What is claimed is:

1. A method of searching for and acquiring handover information, comprising:
receiving the location information of an information server, which can provide the handover information, from a Dynamic Host Configuration Protocol (“DHCP”) server;
accessing the information server using the location information; and
receiving the handover information from the information server.

2. The method of claim 1, wherein receiving the location information comprises using an option function of a DHCP message.

3. The method of claim 2, wherein using the option function of a DHCP message comprises:
adding a location discovery option, which does not include the location information, to a DHCP message;
transmitting the DHCP message to the DHCP server to request the location information;
receiving a reply DHCP message which includes the location discovery option and the location information; and
analyzing the reply DHCP message to extract the location information.

4. The method of claim 3, wherein the location discovery option comprises:
a field indicating a code of the location discovery option;
a field indicating a length of the location discovery option; and
a field indicating the location information in the reply DHCP message.

5. The method of claim 1, wherein the location information comprises an Internet Protocol (“IP”) address of the information server.

6. The method of claim 5, wherein the IP address of the information server is in Internet Protocol Version 6 (IPv6) format.

7. The method of claim 1, wherein the location information comprises a Fully Qualified Domain Name (“FQDN”) of the information server.

8. The method of claim 1, wherein the location information comprises a Uniform Resource Identifier (“URI”) for the handover information.

9. The method of claim 1, wherein the location information comprises an Internationalized Resource Identifier (“IRI”) for the handover information.

10. An apparatus for searching for and acquiring handover information, comprising:
a information receiver to receive the location information of an information server, which provides the handover information, from a Dynamic Host Configuration Protocol (“DHCP”) server;
an access unit to access the information server, using the location information; and
a handover information receiver to receive the handover information from the information server.

11. The apparatus of claim 10, wherein the information receiver receives the location information using an option function of a Dynamic Host Configuration Protocol (“DHCP”) message.

12. The apparatus of claim 11, wherein the information receiver comprises:
an option adder to add a location discovery option, which does not include the location information, to a DHCP message;
a DHCP message transmitter to transmit the DHCP message to the DHCP server to request the location information;
a DHCP message receiver to receive a reply DHCP message from the DHCP server which includes a location discovery option and the location information; and
a DHCP message analyzer to analyze the reply DHCP message to extract the location information.

13. The apparatus of claim 12, wherein the location discovery option comprises:
a field indicating the code of the location discovery option;
a field providing the length of the location discovery option; and
a field to contain the location information in the reply DHCP message.

14. The apparatus of claim 10, wherein the location information comprises the Internet protocol (“IP”) address of the information server.

15. The apparatus of claim 14, wherein the IP address of the information server is in Internet Protocol Version 6 (IPv6) format.

16. The apparatus of claim 10, wherein the location information comprises a Fully Qualified Domain Name (“FQDN”) of the information server.

17. The apparatus of claim 10, wherein the location information comprises a Uniform Resource Identifier (“URI”) for the handover information.

18. The apparatus of claim 10, wherein the location information comprises an Internationalized Resource Identifier (“IRI”) for the handover information.

19. A computer readable medium having embodied thereon a computer program for executing a method comprising:
receiving the location information of an information server, which can provide handover information, from a Dynamic Host Configuration Protocol (“DHCP”) server;
accessing the information server using the location information; and
receiving the handover information from the information server.

20. The computer readable medium of claim 19, wherein the location information comprises an IP address of the information server in an Internet Protocol version 6 (IPv6) format.
